(19) United States
(12) Patent Application Publication
(10) Pub. No.: US 2026/0313044 A1
(43) Pub. Date: Oct. 8, 2026

(54) FIRST NODE, FIRST SECOND NODE AND METHODS PERFORMED THEREBY, FOR HANDLING AN INTENT

(71) Applicant: Telefonaktiebolaget LM Ericsson (publ), Stockholm (SE)

(72) Inventors: Josue CASTANEDA CISNEROS, Sundbyberg (SE); Dagnachew Azene TEMESGENE, Johanneshov (SE); Mirko D'ANGELO, Göteberg (SE); András ZAHEMSZKY, Sollentuna (SE)

(21) Appl. No.: 19/482,473

(22) PCT Filed: May 11, 2023
(86) PCT No.: PCT/SE2023/050465

§ 371 Date: Nov. 7, 2025

(51) Int. Cl. H04L 67/63

(52) U.S. Cl. CPC H04L 67/63

(57) ABSTRACT

A computer-implemented method performed by a first node. The method may be understood to be for handling an intent. The first node obtains respective first information from one or more second nodes. The one or more second nodes operate in the communications network. The one or more second nodes are candidates to handle the intent in the communications network. The respective first information indicates: i) one or more respective first indications of a performance of the respective one or more second nodes, ii) one or more respective second indications of a respective context of the one or more respective first indications, and iii) one or more respective third indications of a respective estimate of an expected outcome of performing the intent. The first node then determines, based on the obtained respective first information, whether or not one of the one or more second nodes, is to handle the intent.

### TECHNICAL FIELD

The present disclosure relates generally to a first node and methods performed thereby for handling an intent. The present disclosure further relates generally to a first second node and methods performed thereby, for handling the intent. The present disclosure also relates generally to computer programs and computer-readable storage mediums, having stored thereon the computer programs to carry out these methods.

### BACKGROUND

Computer systems in a communications network or communications system may comprise one or more nodes. A node may comprise a processing circuitry which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

Wireless devices within a communications network may be e.g., User Equipments (UE), stations (STAs), mobile terminals, wireless terminals, terminals, and/or Mobile Stations (MS). Wireless devices are enabled to communicate wirelessly in a communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

In the course of operations of the communications network, data may be collected on the performance of the telecommunications network, which may enable to monitor and manage the malfunctioning of any of its elements.

The advent of for example, the Internet of Things (IoT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected and enable an improved management of the operation of the telecommunications network.

### Machine Learning

Machine learning (ML) may be understood as the study of computer algorithms that may improve automatically through experience. It is seen as a part of Artificial Intelligence (AI). ML algorithms may build a model based on sample data, known as “training data”, in order to make predictions or decisions without being explicitly programmed to do so. ML algorithms may be used in a wide variety of applications, such as email filtering and computer vision, where it may be difficult or unfeasible to develop conventional algorithms to perform the needed tasks.

There may be basically 3 types of ML Algorithms: Supervised Learning, Unsupervised Learning, and Reinforcement Learning (RL).

Supervised Learning algorithms may comprise a target/outcome variable, or dependent variable, which may have to be predicted from a given set of predictors, that is, independent variables. Using this set of variables, a function may be generated that may map inputs to desired outputs. The training process may continue until the model may achieve a desired level of accuracy on the training data. Once an ML model may have been trained, an inference process may begin, whereby new data may be run through the ML model to calculate an output. Examples of Supervised Learning may be Regression, Decision Tree, Random Forest, KNN, Logistic Regression etc.

In Unsupervised Learning algorithms, there may be no target or outcome variable to predict/estimate. It may be used for clustering a population into different groups, which may be widely used for segmenting customers in different groups for specific intervention. Examples of Unsupervised Learning may be K-means, mean-shift clustering, Density-Based Spatial Clustering of Applications with Noise (DBSCAN), Expectation-Maximization (EM) Clustering using Gaussian Mixture Models (GMM), Agglomerative Hierarchical Clustering, etc. . . . .

Cluster analysis or clustering may be understood as an ML technique which may comprise grouping a set of objects in such a way that objects in the same group, which may be called a cluster, may be understood to be more similar, in some sense, to each other than to those in other groups, that is, other clusters. It may be understood as a main task of exploratory data mining, and a common technique for statistical data analysis, used in many fields, including pattern recognition, image analysis, information retrieval, bioinformatics, data compression, computer graphics and ML.

Using an RL algorithm, a machine may be trained to make specific decisions. It may be understood to work as follows: the machine may be exposed to an environment where it may train itself continually using trial and error. This machine may learn from past experience and may try to capture the best possible knowledge to make accurate business decisions. An example of RL may be a Markov Decision Process (MDP). The training using RL may comprise generating an ML model. To train such an ML model, an agent, given a state of the environment, may take an action in this environment and receive a reward. The action may result in a new state of the environment. This process may be repeated in a loop. Over time, the agent may learn to take actions that may result in larger immediate and future rewards, meaning that it may be understood to be in the best interest of the agent not to take the action that may only lead to the highest reward in the next state, but the action that may cumulatively lead to the highest reward in the next state and in a future number of states.

The agent may comprise a neural network which may input the state and may produce an action. There may be several ML algorithms that may be used for training the network of the agent, e.g., policy-learning based, such as actor-critic approaches or value-based learning such as deep-q networks.

### NR

The standardization organization 3rd Generation Partnership Project (3GPP) is currently in the process of specifying a New Radio Interface called New Radio (NR) or 5G-Universal Terrestrial Radio Access (UTRA), as well as a Fifth Generation (5G) Packet Core Network, which may be referred to as Next Generation (NG) Core Network, abbreviated as NG-CN, NGC or 5G CN.

In the current concept, gNB denotes an NR BS, where one NR BS may correspond to one or more transmission and/or reception points.

One of the main goals of NR is to provide more capacity for operators to serve ever increasing traffic demands and variety of applications. Because of this, NR may be able to operate on high frequencies, such as frequencies over 6 GHZ, until 60 or even 100 GHz.

Operation in higher frequencies makes it possible to use smaller antenna elements, which enables antenna arrays with many antenna elements. Such antenna arrays facilitate beamforming, where multiple antenna elements may be used to form narrow beams and thereby compensate for the challenging propagation properties.

### Intent Management

The context of the ideas presented in this document is the intent manager (IM), or intent management function (IMF), that may be understood to provide a zero-touch control for an environment. FIG. 1 is a schematic diagram depicting an IM 1. The IM 1 may be understood to be controlled by one or more intents 2 and may control one or more environments 3. The one or more intents 2 may be received from an operator 4. Controlling an environment 3 may be performed by observing the environment 3, reasoning 5 around the combination of perceived situation, percepts 6 acquired via a sensor 7, and prior knowledge 8, and taking actions 9, via an actuator 10, on the environment 3. It may be noted that these steps together may form a closed loop. The overall purpose of the intent manager 1 may be understood to be to fulfil the intent 2. The figure is based on: Stuart J. Russel, Peter Norvig 2003: “Artificial Intelligence, A Modern Approach” (2013) [5].

An intent may be defined as “the formal specification of all expectations including requirements, goals, and constraints given to a technical system”. Examples of expectations may be “At least 95% of the URLLC users shall experience a latency of maximum 20 msec”, or “At least 80% of the users of the conversational video service shall have a minimum Quality of Experience (QoE) of 4.0”, or “Energy consumption of the system shall be kept to a minimum”. More detailed information on intents and how they relate to closed loops may be found in the article “Intent-driven Closed Loops for Autonomous Networks” [3].

When applying the mechanism schematically depicted in FIG. 1 to a mobile network, the environment under control may be understood to be the mobile network, and the operator may be understood to be the, e.g., human, network operator. It may be noted that, for scalability reasons, the network may typically be divided into multiple domains, that is, environments. Furthermore, intent managers may come in a hierarchy. In general, the environment under control may be a part of the mobile network or may be another IM. The operator may be a portal to the human network operator or may be another IM.

A more elaborate description on intents and the architecture around intents may be found in TM Forum specifications such as “TM Forum Introductory Guide: Autonomous Networks-Technical Architecture” (IG1230) [4] or “TM Forum Introductory Guide: Intent in Autonomous Networks” (IG1253) [1]. These specifications also include intent managers and the envisioned hierarchy of intent managers.

FIG. 2 is a schematic representation of hierarchical intent handling, corresponding to Figure 7-2 of IG1253 Intent in Autonomous Networks v. 1.3.0, and is described in such document as follows. FIG. 2 shows an example of multiple intent management functions with their individual responsibility scopes. It may be noted that the arrow representing the intent interface is depicted as bi-directional. This may include the direction of intent setting as well as the direction of intent reporting between intent management functions.

In this example, there is one intent handling function in business operation. It receives its intent from contract and order management. This intent may originate from the Service-Level Agreements (SLAs), and it may reflect the contractual obligation towards a customer and the needs of the respective users. While contract and order management may be an automated system that may generate intent, further intent may come directly from human personnel of the customer. Also, the operator's personnel may inject further intent directly into the autonomous system. Human intent setting may be performed through respective frontend. In this example, customer and business portals are shown. Both are human interface frontend allowing direct or indirect intent specification by humans.

In the service operation layer, this example depicts three distinct intent management function. An Operations support systems (OSS) intent manager may receive all intent for service operation coming from the business operations layer. This intent manager may then decide the service operation processes that may be needed. It may break down the received goals and requirements into suitable instrumental goals. These may then be distributed to sub-domains of service operation as intent. In FIG. 2, two sub-domains are shown: Orchestration and Network management. However, this may be understood to be only an example of the principles of Intent-driven operation. In a real-world autonomous network, there may be more and potentially different domains and layers from the ones shown here.

Resource operation may comprise multiple autonomous domains, depicted in the Figure as Autonomous Domain (AD) 1, AD2, and ADd. Using the intent mechanism, it may be possible that service operation may interact with each autonomous domain through intent. Typically, intent management functions within service operation may decide what goals and requirements each autonomous domain may need to fulfil. These are the instrumental goals of service operation. These goals may be reflected in a set of distinct, but coordinated intent objects, each targeting the intent handler within an autonomous domain.

Delegating intents is a complex problem. On the one hand, the intent expectations may not be fulfilled by an IM whose resources may be overstretched. On the other hand, networks may change over time; thus, requirements that appear to be non-stringent, may suddenly become so. Since not satisfying such expectations, network operators may like to minimize their liability risk by carefully selecting which IM may handle a given intent. FIG. 3 shows a use case that illustrates the problem being addressed, of delegating an intent between two managers.

According to the exemplary use case schematically depicted in FIG. 3, a first intent owner 30, Intent Owner 1, shown on the left top of FIG. 3, receives a request from a contract and order management. It decides to create intent A 31, sends the intent to the second intent manager 32, Intent Manager 2, running in the service operation layer 33, who accepts it. Consider that the network is partitioned in two geographical regions, in this case North 34 and South of Stockholm 35, as shown in the right-most part of FIG. 3. The second intent owner 32 wants to delegate further an intent B to meet the expectations of the first intent 31. The second intent owner 32 knows there are two intent handlers, Intent Handler 1 36 and Intent Handler 2 37, capable of taking the intent B, since they provide the required capabilities, as specified in the standard. The second intent owner 32 now must decide which of these two managers will be asked to handle the new intent B, i.e., where to send Intent B. In other words, it must decide under uncertainty. To cope with the uncertainty problem, the standardization TM Forum proposes an Application Programming Interface (API) for intent lifecycle management [1,2].

The lifecycle management API may consider both required and optional interfaces. Negotiation under uncertainty is considered in the optional procedures PREFERENCE, PROBE, and BEST. The PROBE procedure may be considered herein, since it may allow to explore the potential handling results on an intent. FIG. 4 is a signalling diagram illustrating from TM Forum IG 1253C v. 1.1.0 showing a procedure using the PROBE interface. At Step 1, observations from outside the intent mechanism arrive at an Intent Manager 1, the intent owner. According to a DETECTION phase, the IM 1 identifies the need for intent and according to an INVESTIGATION phase, the IM 1 assesses the available intent handlers and their capabilities. IM1 creates an intent object to test its expected result and sends this intent to the intent handler, IM 2. At step 2, IM 1 decides to send the wanted intent to the intent handler via the PROBE procedure. This may be understood to mean that the owner may ask the handler to evaluate the potential outcome of the intent. IM 2, according to an INVESTIGATION phase, prepares a first report, accepting the intent for probing. In steps 3-5 the intent handler presents reports to the intent owner, describing what the expected outcome would be if the intent would be added. At step 3, IM 2 sends report 1 for intent 1 to IM 1, at step 4, report 2 for intent 1, at step 5, report 3 for intent 1. After receiving each of report 2 and report 3, IM 1, according to a respective INVESTIGATION phase, evaluates the reported hypothetical handling results. After receiving the reports, the owner decides to remove the PROBE intent. At step 6, IM 1, sends an instruction to remove intent 1 to IM 2. IM 2, according to an INVESTIGATION phase, decides to send the last report and removal confirmation. At step 7, IM 2 sends report 4 for intent 1. IM 1 then, according to a DEFINITION phase, creates and formulates the needed intent objects. According to a DISTRIBUTION phase, IM 1 sends the wanted intent to handlers. Finally, at step 8, IM 1 sends intent 2 to the intent handler, IM 2. IM 2, according to an OPERATION phase, prepares the first report for intent 2, accepting the intent. At step 9, step 10 and step 11, respectively, IM 2 sends report 5, report 6 and report 7, respectively, for intent 2, to IM 1.

The case of multiple intent managers is generalized in the signalling diagram of FIG. 5. FIG. 5 depicts how an intent owner may select a candidate from multiple handlers using only the PROBE procedure. This may be understood to be a generalized picture from FIG. 4. Selecting the best candidate may be understood to be a multi-step procedure using the PROBE interface. First, in the DETECTION phase, the intent owner may decide an intent A needs to be sent to an intent manager. After this, the INVESTIGATION phase may try to estimate what is the expected outcome if the wanted intent is used in any of the intent managers detected in step 2, in this example, IM 1 and IM 2. After detecting the intent handlers, the intent owner may send a PROBE request to both intent handlers at steps 2.1 and 2.2, respectively, which may contain the probing intent A. Both reply positively, this means that they will send reports to the intent owner. These reports represent the estimate of handling the intent if it would be set. IM 1 and IM 2, at steps 2.3 and 2.4, respectively, in an INVESTIGATION phase, may accept the reporting. In steps 3-8, both intent handlers may send their reports to the owner. At step 3, IM 1 mat send report 1 on intent A, and at step 4, IM 2 may send report 1 on intent A. At steps 5 and 6, respectively, in a respective INVESTIGATION phase, each of IM 1 and IM 2 may investigate whether to send a report, and at each of step 7, and step 8 IM 1 and IM 2 may respectively send a report 2 on intent A. The owner may revise the first reports in step 9, in an INVESTIGATION phase. More reports may be sent until the probing intent may be removed by the owner, as shown in steps 10-13. At each of step 10, and step 11, IM 1 and IM 2 may respectively send a report 3 and report 4 on intent A. In step 12, the intent owner may decide, in an INVESTIGATION phase of the reports, which intent handler may get the intent B considering the reports he obtained from the two intent handlers. First, the intent owner, at step 13, in an INVESTIGATION phase, may decide to stop probing, and may then remove the probing intent A from each of IM 1, and IM 2, at Step 14 and Step 15 respectively. This may trigger an INVESTIGATION phase at each of IM 1 and IM 2 in steps 16 and 17, respectively, about the last report. At step 18, based on the reports received from both intent handlers, the intent owner may, in an INVESTIGATION phase, define the intent and choose the first intent manager for the intent. Finally, at step 19 the intent owner may set the intent, intent A, to the first intent manager.

Existing methods to handle intents in a communications network, may result in poor selection of intent handlers, and consequently, of intents.

### SUMMARY

As part of the development of embodiments herein, one or more problems with the existing technology will first be identified and discussed.

Currently, the decision to select a candidate falls solely on the estimates provided by the intent handlers. In other words, if the accuracy and precision of the estimates are poor, the decision to select that intent handler will also be poor.

It is therefore an object of embodiments herein to improve the handling of an intent in a communications network.

According to embodiments herein a performance metric to be sent for intent handlers may be added, in addition to the current estimates for the intent. This extra information may add contextual information that may allow the intent owner to improve the estimates being sent by the handlers.

According to a first aspect of embodiments herein, the object is achieved by a computer-implemented method, performed by a first node. The method is for handling an intent. The first node operates in a communications network. The network node obtains respective first information from one or more second nodes. The one or more second nodes operate in the communications network. The one or more second nodes are candidates to handle the intent in the communications network. The respective first information indicates: i) one or more respective first indications of a performance of the respective one or more second nodes, ii) one or more respective second indications of a respective context of the one or more respective first indications, and iii) one or more respective third indications of a respective estimate of an expected outcome of performing the intent. The first node then determines, based on the obtained respective first information, whether or not one of the one or more second nodes, is to handle the intent.

According to a second aspect of embodiments herein, the object is achieved by a computer-implemented method, performed by a first second node node. The method is for handling the intent. The first second node operates in the communications network. The first second node provides the respective first information to the first node operating in the communications network. The first second node is one of one or more second nodes that are candidates to handle the intent in the communications network. The respective first information indicates: i) the one or more respective first indications of the performance of the first second node, ii) the one or more respective second indications of the respective context of the one or more respective first indications, and iii) the one or more respective third indications of the respective estimate of the expected outcome of performing the intent.

According to a third aspect of embodiments herein, the object is achieved by the first node. The first node may be understood to be for handling the intent. The first node is configured to operate in the communications network. The first network node is further configured to obtain the respective first information from the one or more second nodes. The one or more second nodes are configured to operate in the communications network. The one or more second nodes are configured to be candidates to handle the intent in the communications network. The respective first information is configured to indicate: i) the one or more respective first indications of the performance of the respective one or more second nodes, ii) the one or more respective second indications of the respective context of the one or more respective first indications, and iii) the one or more respective third indications of the respective estimate of the expected outcome of performing the intent. The first node is additionally configured to determine, based on the respective first information configured to be obtained, whether or not one of the one or more second nodes, is to handle the intent.

According to a fourth aspect of embodiments herein, the object is achieved by the first second node. The first second node may be understood to be for handling the intent. The first second node is configured to operate in the communications network. The first second node is configured to provide the respective first information to the first node configured to operate in the communications network. The first second node is configured to be one of one or more second nodes that are configured to be candidates to handle the intent in the communications network. The respective first information is configured to indicate: i) the one or more respective first indications of the performance of the first second node, ii) the one or more respective second indications of the respective context of the one or more respective first indications, and iii) the one or more respective third indications of the respective estimate of the expected outcome of performing the intent.

According to a fifth aspect of embodiments herein, the object is achieved by a computer program, comprising instructions which, when executed on at least one processing circuitry, cause the at least one processing circuitry to carry out the method performed by the first node.

According to a sixth aspect of embodiments herein, the object is achieved by a computer-readable storage medium, having stored thereon the computer program, comprising instructions which, when executed on at least one processing circuitry, cause the at least one processing circuitry to carry out the method performed by the first node.

According to a seventh aspect of embodiments herein, the object is achieved by a computer program, comprising instructions which, when executed on at least one processing circuitry, cause the at least one processing circuitry to carry out the method performed by the first second node.

According to an eighth aspect of embodiments herein, the object is achieved by a computer-readable storage medium, having stored thereon the computer program, comprising instructions which, when executed on at least one processing circuitry, cause the at least one processing circuitry to carry out the method performed by the first second node.

By obtaining the respective first information from the one or more second nodes, the first node may then be enabled to better weigh the respective estimate sent by each of the one or more second nodes.

By determining whether or not one of the one or more second nodes is to handle the intent based on the obtained respective first information, the first node may be enabled to perform an informed decision-making when there may be more than one capable intent handler. This may in turn result in an overall improvement in intent satisfaction since intents may be delegated to more capable intent handlers. Furthermore, the informed decision making that may be enabled by embodiments herein may result in an improved stability of the system since it may minimize the exchange of unmet intent reports through a hierarchy of intent managers. Moreover, the better decision making performed by the first node may have additional advantages, such as reducing costs to intent owners. Reduction of costs for intent owners, and by extension intent handlers, may be achieved in two-fold. First, by having a better estimate than the one provided by the intent manager for a single intent, the first node may reduce the probability to recall the intent. In other words, even though it may be possible to change the intent handler after the first selection, this correction mechanism may be understood to not be cost-free, as liabilities may need to be considered since the expectations of the intent were not met. Thus, there may be understood to be advantageous to be able to reduce this corrective mechanism. Second, having a better estimate than the one currently provided by only the PROBE interface may be understood to help to match the intent expectations and capabilities of the intent manager. This may be understood to mean that by adding this information to the other optional interfaces, e.g., PROPOSE, BEST, the first node may be enabled to adjust expectations of an intent manager better, reducing the number of times the intent may need to be recalled from an intent manager.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of an intent manager, according to existing methods.

FIG. 2 is a schematic diagram illustrating a non-limiting example of hierarchical intent handling, according to existing methods.

FIG. 3 is a schematic diagram illustrating a non-limiting example of delegating an intent between two managers, according to existing methods.

FIG. 4 is a signalling diagram illustrating a non-limiting example of a PROBE interface, from TM Forum IG 1253C v. 1.1.0, according to existing methods.

FIG. 5 is a signalling diagram illustrating a non-limiting example of a selecting a candidate intent manager using the PROBE API, according to existing methods.

FIG. 6 is a schematic diagram illustrating a non-limiting example of a communications network, according to embodiments herein.

FIG. 7 is a flowchart depicting a method in a first node, according to embodiments herein.

FIG. 8 is a flowchart depicting a method in a first second node, according to embodiments herein.

FIG. 9 is a schematic diagram illustrating a non-limiting example of selecting a candidate intent manager using the PROBE API and the Performance Metric with contextual information, according to embodiments herein.

FIG. 10 is a schematic block diagram illustrating an embodiment of a first node, according to embodiments herein.

FIG. 11 is a schematic block diagram illustrating an embodiment of first second node, according to embodiments herein.

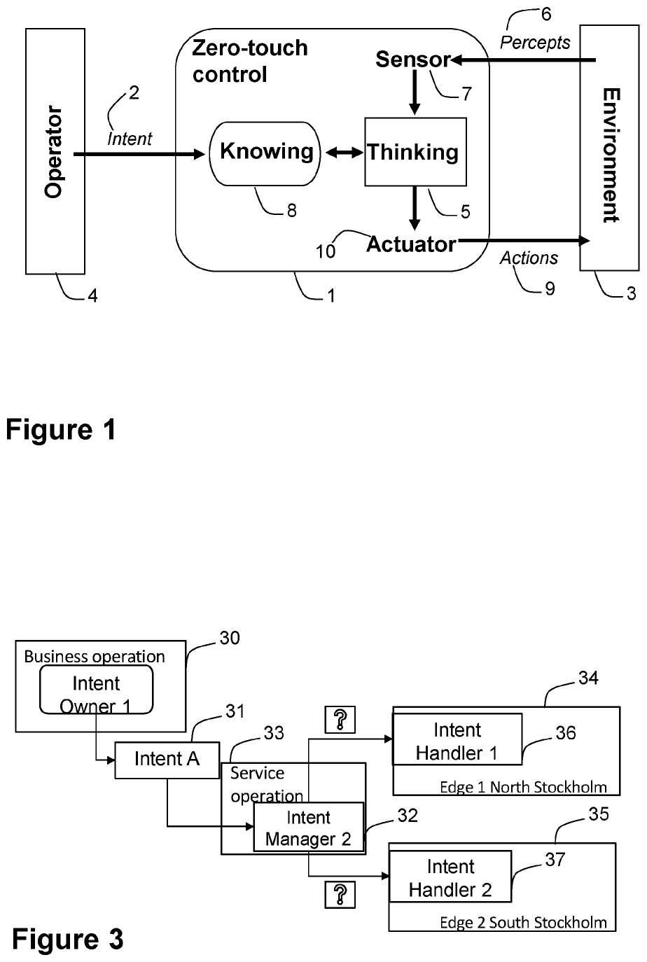

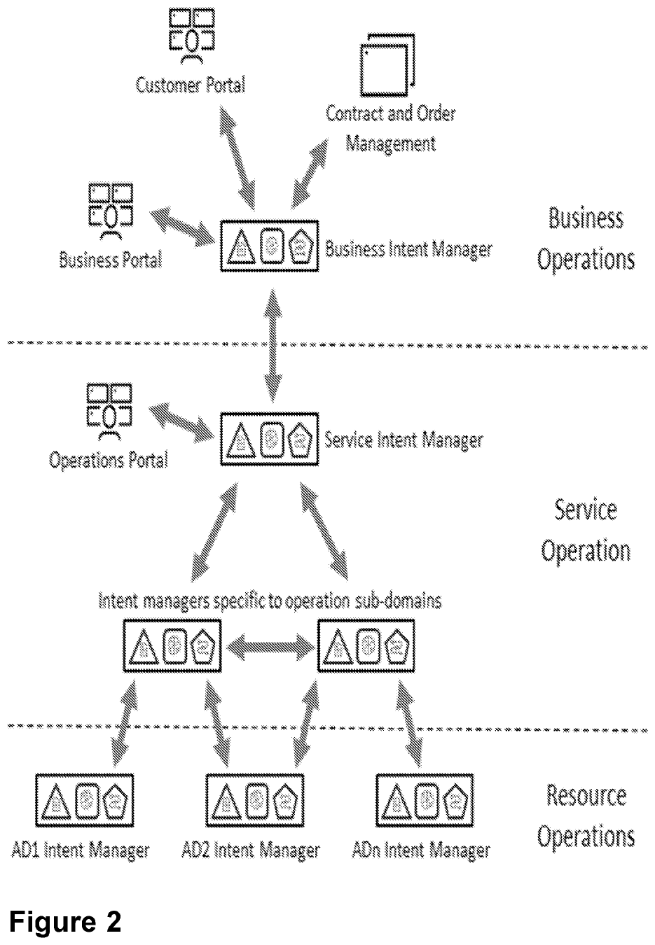

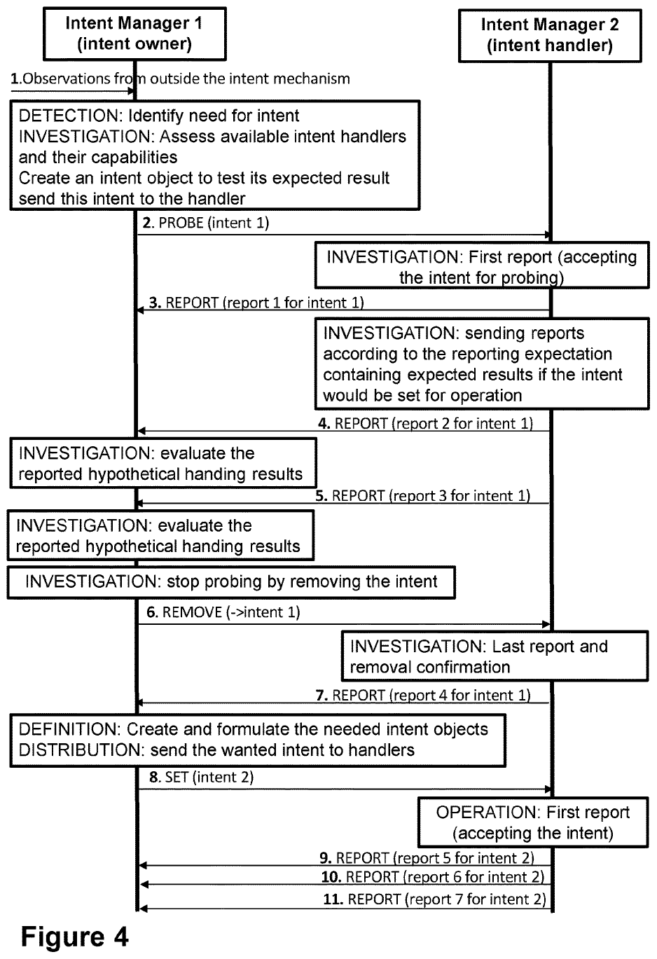

### DETAILED DESCRIPTION

Certain aspects of the present disclosure and their embodiments address the challenges identified in the Background and Summary sections with the existing methods and provide solutions to the challenges discussed.

Embodiments herein may be understood to relate to a performance metric of intent handlers to select the best candidate in a multi-participant negotiation. Particular embodiments herein may be understood to relate to choosing the best intent handler when there may be multiple candidates for a given intent. Currently, the TM Forum Intent Standard considers APIs to estimate the results if an intent is given to an intent manager [1]. However, currently there is no way to validate the prediction for expectations given by the intent handler.

Embodiments herein may be understood to relate to adding performance information to the report of the current probe mechanism. Particular embodiments herein may be understood to relate to adding a performance metric and contextual information to be sent by intent handlers in addition to the estimates of intent expectations. This may enhance the decision-making by an intent owner while delegating intents and may increase the overall intent satisfaction rate of the system. According to embodiments herein, the intent owner may make a better-informed decision to select one intent manager over another.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

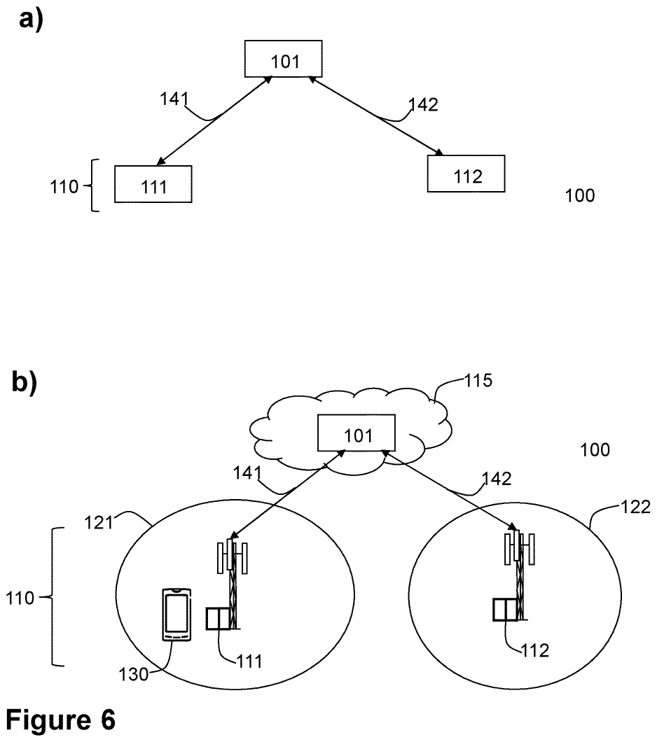

FIG. 6 depicts three non-limiting examples, in each of panels a) and b), respectively, of a communications network 100, in which embodiments herein may be implemented. In some example implementations, such as that depicted in the non-limiting example of FIG. 6a), the communications network 100 may be a computer network. In other example implementations, such as that depicted in the non-limiting example of FIG. 6b), the communications network 100 may be implemented in a telecommunications system, sometimes also referred to as a cellular radio system, cellular network or wireless communications system. In some examples, the telecommunications system may comprise network nodes which may serve receiving nodes, such as wireless devices, with serving beams.

In some examples, the telecommunications system may for example be a 5G system, 5G network, NR-U or Next Gen System or network. The communications network 100 may support a newer system than a 5G system, such as, for example, a 6G system. The communications network 100 may support other technologies, such as, for example Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, Licensed-Assisted Access (LAA), MulteFire etc. Other examples of other technologies the communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system. Thus, although terminology from 5G/NR and LTE may be used in this disclosure to exemplify embodiments herein, this should not be seen as limiting the scope of the embodiments herein to only the aforementioned systems.

The communications network 100 comprises a plurality of nodes, whereof a first node 101 and a one or more second nodes 110 are depicted in FIG. 6. The one or more second nodes 110 comprise at least a first second node 111. In the non-limiting example of FIG. 6, and for illustration purposes only, the one or more second nodes 110 comprise the first second node 111, and a second second node 112. It may be understood that this is for illustration purposes only, and that the one or more second nodes 110 may comprise further or fewer second nodes.

Any of the first node 101 and the one or more second nodes 110, such as the first second node 111 and the second second node 112 may be understood, respectively, as a first computer system or server, and one or more second computer systems or servers. Any of the first node 101 and the one or more second nodes 110, such as the first second node 111 and the second second node 112 may be implemented as a standalone server in e.g., a host computer in the cloud 115, as depicted in the non-limiting example of FIG. 6b) for the first node 101. In other examples, any of the first node 101 and the one or more second nodes 110, such as the first second node 111 and the second second node 112 may be a distributed node or distributed server, such as a virtual node in the cloud 115, and may perform some of its respective functions locally, e.g., by a client manager, and some of its functions in the cloud 115, by e.g., a server manager. In other examples, any of the first node 101 and the one or more second nodes 110, such as the first second node 111 and the second second node 112 may perform its functions entirely on the cloud 115, or partially, in collaboration or collocated with a radio network node. Yet in other examples, any of the first node 101 and the one or more second nodes 110, such as the first second node 111 and the second second node 112 may be may also be implemented as processing resources in a server farm. Any of the first node 101 and the one or more second nodes 110, such as the first second node 111 and the second second node 112 may be under the ownership or control of a service provider or may be operated by the service provider or on behalf of the service provider.

Any of the first node 101 and the one or more second nodes 110, such as the first second node 111 and the second second node 112 may be a radio network node, capable of serving a wireless device, for example, a user equipment or a machine type communication device, in the communications network 100.

Any of the first node 101 and the one or more second nodes 110, such as the first second node 111 and the second second node 112 may be a base station, such as a gNB in 5G or an eNB in 4G. In other examples, any of the first node 101 and the one or more second nodes 110, such as the first second node 111 and the second second node 112 may be a distributed node, such as a virtual node in the cloud, and may perform its functions entirely on the cloud, or partially, in collaboration with a radio network node.

Any of the first node 101 and the one or more second nodes 110, such as the first second node 111 and the second second node 112, in some examples, may be a core network node.

The communications network 100 may cover a geographical area, which in some embodiments may be divided into cell areas, wherein each cell area may be served by a radio network node, although, one radio network node may serve one or several cells. In the example of FIG. 6 panel b), the first second node 111 serves a first cell 121 and the second second node 112 serves a second cell 122. Any of the first node 101 and the one or more second nodes 110, e.g., the first second node 111 and the second second node 112 may be of different classes, such as, e.g., macro eNodeB, home eNodeB or pico base station, based on transmission power and thereby also cell size. In some examples, any of the first node 101 and the one or more second nodes 110, e.g., the first second node 111 and the second second node 112 may serve receiving nodes with serving beams. Any of the first node 101 and the one or more second nodes 110, such as the first second node 111 and the second second node 112 may support one or several communication technologies, and their name may depend on the technology and terminology used.

One or more wireless devices 130 may be comprised in the wireless communication network 100. In the non-limiting example of FIG. 6, the only one wireless device 130 is depicted for illustration purposes. The one or more wireless devices 130 may comprise additional wireless devices. Any of the one or more wireless devices 130 comprised in the communications network 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the one or more wireless devices 130 comprised in the communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any of the one or more wireless devices 130 comprised in the communications network 100 may be enabled to communicate wirelessly in the communications network 100. The communication may be performed via the one or more radio network nodes 110 and possibly the one or more core networks, which may be comprised within the communications network 100.

The first node 101 may be configured to communicate with a respective second node over a respective link. In the non-limiting example of FIG. 6, the first node 101 may be configured to communicate within the communications network 100 with the first second node 111 over a first link 141, e.g., a radio link or a wired link. The first node 101 may be configured to communicate within the communications network 100 with the second second node 112 over a second link 142, e.g., a radio link or a wired link.

In general, the usage of “first”, “second”, “third” and/or “fourth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first node, such as the first node 101, e.g., a gNB or a core network node, and embodiments related to a first second node, such as the first second node 111 e.g., another gNB.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

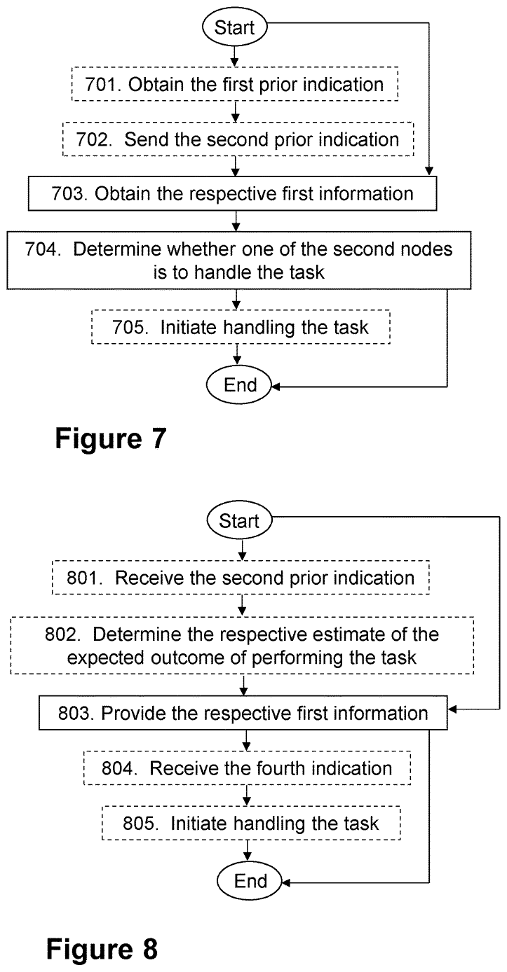

Embodiments of a computer-implemented method, performed by the first node 101, will now be described with reference to the flowchart depicted in FIG. 7. The method is for handling an intent. The first node 101 operates in the communications network 100.

Several embodiments are comprised herein. In some embodiments all the actions may be performed. In some embodiments, some actions may be optional. In FIG. 7, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description.

In some embodiments, the method may be performed using the PROBE or BEST interfaces (TMF921A). In 3GPP API, the terms may be different, but similar functionalities will be found. For example, by extending QUERY functionalities as specified in TS 28.312 v.17.3.1.

### Action 701

In this Action 701, the first node 101 may obtain a first prior indication indicating a first intent to be handled. The first node 101 may be at least one of an intent owner and an intent handler.

Obtaining in this Action 701 may comprise receiving, directly or indirectly, from e.g., an operator of the communications network 100, or another node operating in the communications network 100.

### Action 702

In some embodiments, in this Action 702, the first node 101 may send a second prior indication to the one or more second nodes 110. The one or more second nodes 110 may be understood to be candidates to handle the intent, that is, the first intent, using artificial intelligence methods. Artificial intelligence methods may comprise, for example, machine-learning (ML) methods such as, and not limited to: multi-agent reinforcement learning and neural networks. AI techniques may not be limited to ML techniques but may be realized by using symbolic representation of knowledge and models to reason about them using methods mostly derived from logic, also known as machine reasoning (MR). Each of the one or more second nodes 110 may be understood to be an intent handler.

The second prior indication may indicate a respective second intent of one or more second intents to be handled. The one or more second intents may be based on the indicated first intent. At least one of the following may apply: a) the one or more second intents may be one of: the same, and different from each other, and b) the one or more second intents may have been split from the first intent.

The sending in this Action 702 may be performed e.g., via the first link 141 and the second link 142.

The first node 101 may perform this Action 702 responsive to a determination, by the first node 101 that, among other reasons, for example, certain requirements could not be met given the resources of a handler, specific goals, e.g., outside resources, may not be fulfilled, such as security guarantees, new requirements added to an already set intent, or the requirement may have changed, e.g. now the requirement may be stricter, e.g., better Quality of Experience (QoE).

By sending the second prior indication to the one or more second nodes 110 in this Action 702, the first node 101 may be enabled to explore the potential handling results on the second intent. That is, the first node 101, as intent owner, may ask the one or more second nodes 110, as intent handlers, to evaluate the potential outcome of the second intent, and obtain information from the one or more second nodes 110 to probe their ability to handle the second intent.

### Action 703

In this Action 703, the first node 101 obtains respective first information from the one or more second nodes 110. The one or more second nodes 110 operate in the communications network 100. As stated earlier, the one or more second nodes 110 are candidates to handle the intent in the communications network 100. The intent may be one of the one or more second intents.

The obtaining in this Action 703 may be, e.g., receiving and may be performed e.g., via the first link 141 and the second link 142.

The respective first information indicates one or more respective first indications of a performance of the respective one or more second nodes 110. Each of the one or more respective first indications of the performance may be understood as a performance metric, such as, for example, Central Processing Unit (CPU) usage, memory usage, requests per minute, latency and uptime, average response time, error rates, % of expectations fulfilled, % of intents fulfilled, etc., Each of the one or more respective first indications of the performance may be understood to indicate the manager's performance.

The respective first information also indicates one or more respective second indications of a respective context of the one or more respective first indications. The one or more respective second indications may be understood to indicate related contextual information associated with the performance metric such as, for example, number of data samples used for the generation of the performance, data time window of the data samples of the performance metrics, number of active intents, etc.

The respective first information further indicates one or more respective third indications of a respective estimate of an expected outcome of performing the intent. That is, each of the one or more respective third indications may comprise a report with the estimate of the hypothetical probing intent. The estimate may be performed after sending an intent object to the handler, asking the handler to not consider it in actual operation decisions and actions. The handler may then estimate what the outcome may be if the intent were to be really set by the owner. This estimation may be up to the intent handler to implement, it may be via predictive machine learned models, such as decision trees, regression, neural networks, and/or digital twins that may be used to gain this capability.

In some embodiments, the respective estimate of the expected outcome of performing the intent may be based on using artificial intelligence methods.

In some embodiments wherein Action 702 may have been performed, the respective first information may be obtained responsive to the sent second prior indication.

In some embodiments, the respective first information may correspond to a first time period, and the obtaining in this Action 703 may be repeated for each of a plurality of second time periods. After each time period, the performance and contextual information may be updated since their state may be understood to change. For example, one of the one or more second nodes 110 may now handle more intents, which may be understood to impact its performance.

By obtaining the respective first information from the one or more second nodes 110 in this Action 703 the first node 101 may then be enabled to better weigh the respective estimate sent by each of the one or more second nodes 110 and thereby be enabled to perform an informed decision-making to select the best candidate to handle the second intent when there may be more than one capable intent handler. This may then enable the first node 101 to improve intent satisfaction since intents may be delegated to more capable intent handlers. Furthermore, this may in turn result in an improved stability of the system since it may minimize the exchange of unmet intent reports through a hierarchy of intent managers.

### Action 704

In this Action 704, the first node 101 determines, based on the obtained respective first information, whether or not one of the one or more second nodes 110, is to handle the intent. As stated earlier, the intent may be one of the one or more second intents.

Determining may be understood as calculating, deriving or similar.

As a non-limiting example, the first node 101 may, in this Action 704, evaluate how either intent handler may manage the intent by computing a risk of not provisioning the intent via Bayesian inference algorithms. These inference algorithms may try to compute the probability for a hypothesis, e.g., which intent handler to choose given multiple options. They may do so by considering evidence and updating every iteration, this previous information may be known as the prior. While existing methods may have a prior that may be built only with the intent reports, the added information, e.g., performance, context, in embodiments herein may be added evidence that may weigh the prior evidence and update it. It may be noted that every time intent reports may be received by the intent handler, more evidence may be obtained. In other words, the added information in embodiments herein may scale the expected outcome of performing the intent. As a result, the selection of the intent handler may be more accurate and precise considering the added information.

Determining whether or not one of the one or more second nodes 110 is to handle the intent may comprise, in some examples, determining which of the one or more second nodes 110 may be able to handle the intent. If multiple handlers may be found to potentially handle the intent, then the first node 101 may have to select one of those intent handlers to handle the intent. Ultimately, the intent may then be sent to the selected second node, that is, the selected intent handler. In such embodiments, the first node 101 may refrain from sending the intent to other second nodes of the one or more second nodes 110 than the selected second node, that is the selected intent handler.

In some of the embodiments wherein the respective first information may correspond to a first time period, the obtaining in this 703 may be repeated for each of a plurality of second time periods, and the determining in Action 704 may be further based on the obtained respective first information for the first time period and the plurality of second time periods.

The determining performed in this Action 704 may use artificial intelligence methods, such as machine-learning (ML). In such embodiments, the determining in this Action 704 using ML may comprise a training phase, during which the an ML model may be trained, and an inference phase.

The training during the training phase may be performed iteratively.

The inference phase may be understood as a phase wherein the ML model may be executed, or used, to make a particular prediction. The inference phase may be reached once a desired accuracy level of the ML model may have been reached.

By determining whether or not one of the one or more second nodes 110 is to handle the intent based on the obtained respective first information, in this Action 704, the first node 101, as intent owner, may be enabled to perform an informed decision-making when there may be more than one capable intent handler. This may in turn result in an overall improvement in intent satisfaction since intents may be delegated to more capable intent handlers. Furthermore, the informed decision making that may be enabled by embodiments herein may result in an improved stability of the system since it may minimize the exchange of unmet intent reports through a hierarchy of intent managers. Moreover, the better decision making performed by the first node 101 may have additional advantages, such as reducing costs to intent owners. Reduction of costs for intent owners, and by extension intent handlers, may be achieved in two-fold. First, by having a better estimate than the one provided by the intent manager for a single intent, the first node 101, that is, the intent owner, may reduce the probability to recall the intent, that is, the second intent. In other words, even though it may be possible to change the intent handler after the first selection, this correction mechanism may be understood to not be cost-free, as liabilities may need to be considered since the expectations of the intent were not met. Thus, there may be understood to be an interest to reduce this corrective mechanism. Second, having a better estimate than the one currently provided by only the PROBE interface may be understood to help to match the intent expectations and capabilities of the intent manager. This may be understood to mean that by adding this information to the other optional interfaces, e.g., PROPOSE, BEST, the first node 101, that is, the intent owner, may be enabled to adjust the intent manager expectations better, reducing the number of times the intent may need to be recalled from an intent manager.

### Action 705

In some embodiments, the first node 101 may determine a first second node 111 of the one or more second nodes 110 is to handle the intent. In some of these embodiments, in this Action 705, the first node 101 initiates handling the intent via the determined first second node 111. As stated earlier, the intent may be one of the one or more second intents.

Initiating may be understood as starting itself, triggering, e.g., instructing another network node to, or enabling. For example, in this Action 705, the first node 101 may set the intent to the first second node 111.

In some embodiments, at least one of the following may apply. According to a first option, as stated earlier, the one or more second nodes 110 may be candidates to handle the intent using artificial intelligence methods. According to a second option, the respective estimate of the expected outcome of performing the intent may be based on using artificial intelligence methods. According to a third option, the first node 101 may be at least one of the intent owner and the intent handler. According to a fourth option, each of the one or more second nodes 110 may be an intent handler. According to a fifth option, the intent may be one intent of a plurality of intents, and the method may be repeated for each of the other intents in the plurality of intents.

By initiating handling the intent via the determined first second node 111 in this Action 705, the first node 101 may enable an overall improvement in intent satisfaction since intents may be delegated to more capable intent handlers. This may in turn result in the improved stability of the system since it may minimize the exchange of unmet intent reports through the hierarchy of intent managers.

Embodiments of a computer-implemented method, performed by the first second node 111, will now be described with reference to the flowchart depicted in FIG. 8. The method is for handling the intent. The first second node 111 operates in the communications network 100.

Several embodiments are comprised herein. In some embodiments all the actions may be performed. In some embodiments, some actions may be optional. In FIG. 8, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. The detailed description of some of the following corresponds to the same references provided above, in relation to the actions described for the first node 101 and will thus not be repeated here. For example, in some embodiments, the method may be performed using the PROBE interface.

### Action 801

In this Action 801, the first second node 111 may receive the second prior indication from the first node 101 indicating the intent to be handled. In relation to FIG. 8, the intent may be understood to refer to the second intent.

### Action 802

In this Action 802, the first second node 111 may determine, responsive to the received second prior indication, the respective estimate of the expected outcome of performing the intent.

### Action 803

In this Action 803, the first second node 111 provides the respective first information to the first node 101 operating in the communications network 100. The first second node 111 is one of one or more second nodes 110 that are candidates to handle the intent in the communications network 100. The respective first information indicates: i) the one or more respective first indications of the performance of the first second node 111, ii) the one or more respective second indications of the respective context of the one or more respective first indications, and iii) the one or more respective third indications of the respective estimate of the expected outcome of performing the intent.

The provided respective first information may comprise the determined respective estimate of the expected outcome of performing the intent from Action 802.

The respective first information may be provided responsive to the received second prior indication.

### Action 804

In this Action 804, the first second node 111 may receive, based on the provided respective first information, the fourth indication from the first node 101. The fourth indication may indicate the request to handle the intent.

### Action 805

In this Action 805, the first second node 111 may initiate handling the intent responsive to the received fourth indication.

To initiate may be understood as to start itself the actions that may be necessary to fulfil the intent, or to enable or facilitate that another node may do perform such actions.

In some embodiments, the respective first information may correspond to the first time period, and the providing in Action 803 may be repeated for each of the plurality of second time periods, and the receiving in Action 804 may be further based on the sent respective first information for the first time period and the plurality of second time periods.

In some embodiments, at least one of the following may apply. According to the first option, as stated earlier, the one or more second nodes 110 may be candidates to handle the intent using artificial intelligence methods. According to the second option, the respective estimate of the expected outcome of performing the intent may be based on a performance using artificial intelligence methods. According to the third option, the first node 101 may be at least one of the intent owner and the intent handler. According to the fourth option, each of the one or more second nodes 110 may be an intent handler. According to the fifth option, the intent may be one intent of the plurality of intents, and the method may be repeated for each of the other intents in the plurality of intents.

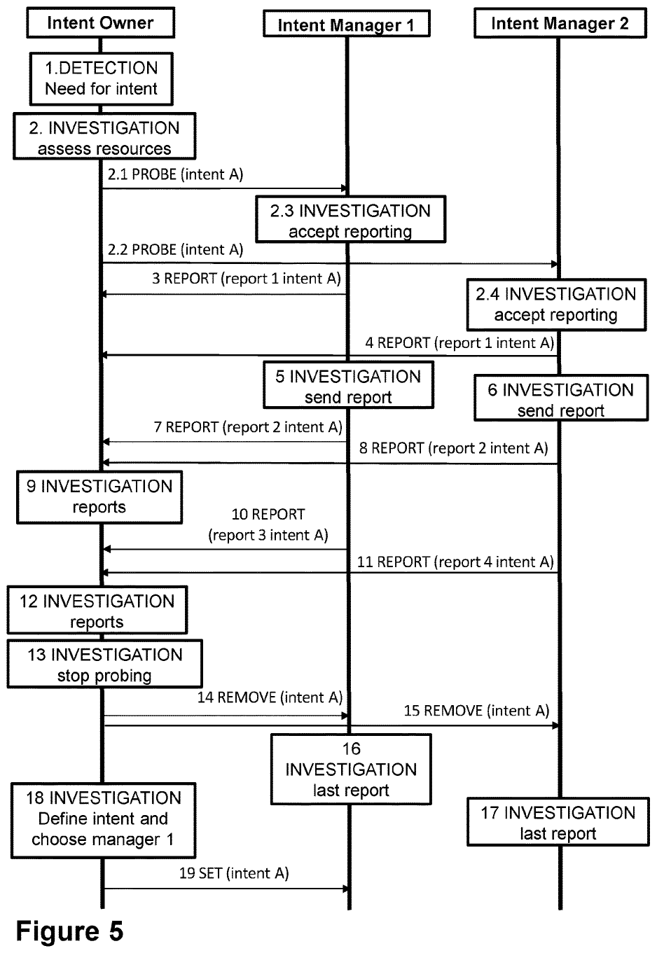

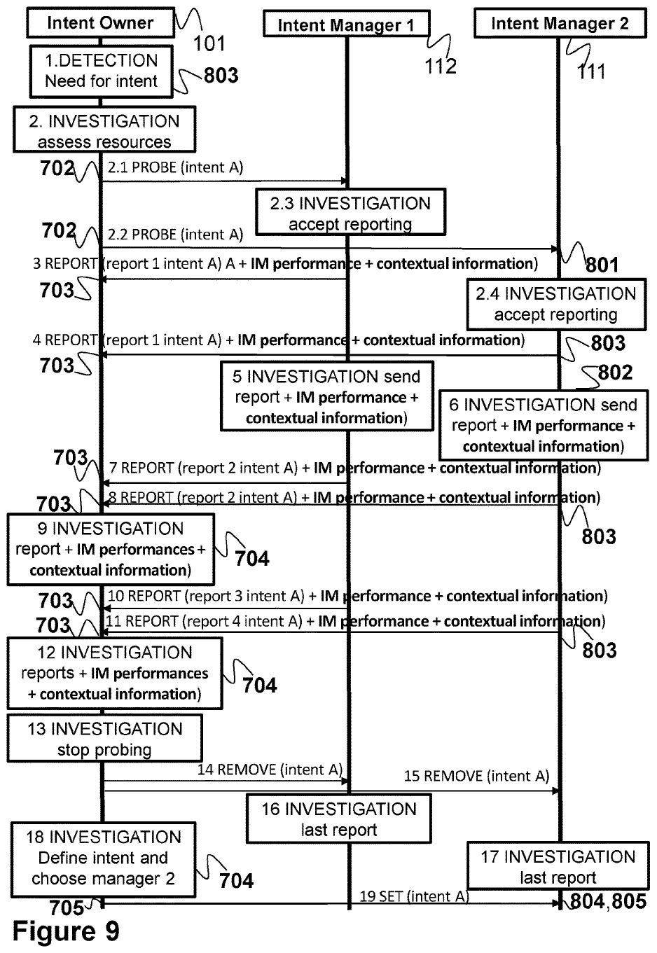

FIG. 9 is a signalling diagram depicting a non-limiting example of the method performed by the first node 101, according to embodiments herein. In this example, the first node 101 is the intent owner. The one or more second nodes 110 comprise two nodes: Intent Manager 1 and Intent Manager 2. Intent Manager 2 is the first second node 111. Intent Manager 1 is the second second node 2. In FIG. 9 the same use case described in the Background section in relation to FIG. 3 and FIG. 5 is considered. In this case, according to embodiments herein, the two intent handlers for each region of Stockholm may now also report: a) the one or more respective first indications of the performance of the respective one or more second nodes 110, that is, the performance metric, such as CPU usage, memory usage, requests per minute, latency and uptime, average response time, error rates, % of expectations fulfilled, % of intents fulfilled, etc., and b) the one or more respective second indications of a respective context of the one or more respective first indications. That is, the related contextual information associated with the performance metric, such as e.g., number of data samples used for the generation of the performance, data time window of the data samples of the performance metrics, number of active intents, etc. . . . . Thus, in FIG. 9, while considering the same corresponding entities as in FIG. 5, the results are different. At Step 1, in accordance with Action 701, observations from outside the intent mechanism may arrive at the first node 101, the intent owner. According to a DETECTION phase, the first node 101 may identify the need for intent and at Step 2, according to an INVESTIGATION phase, the first node 101 may assess the available intent handlers and their capabilities. At steps 2.1 and 2.2, the first node 101 may create the second intent object, indicated in FIG. 9 as “Intent A”, to test its expected result and may, according to Action 702 and 801, send this second intent to the one or more second nodes 110 via the PROBE procedure. This may be understood to mean that the owner may ask each of the first second node 111 and the second second node 112, the handlers, to evaluate the potential outcome of the second intent. Steps 1-2 may be understood to correspond to the steps with the same number as in FIG. 5. In steps 3-8 instead of sending a report with the estimate of the hypothetical probing intent, in accordance with Action 802, the respective manager's performance and contextual information may be also added to the report. Thus, in steps 3 and 4 and 7 and 8, the intent owner may receive the report containing both pieces of information, in accordance with Action 803 and 703. In step 9, the intent owner may, in accordance with Action 704, better weigh the estimate sent by each manager. Consequently, in steps 10 and 11, the managers may send again the new report that may contain the estimates and the new performance information, in accordance with Action 803 and 703. The performance and contextual information may be updated since their state may change. For example, the intent manager may now handle more intents, which may impact its performance. In step 12, the intent owner may now make a better-informed decision to select the best candidate to handle the intent, in accordance with Action 704. Note here that in FIG. 9, by considering the performance metric and contextual information, the intent owner may now delegate the new intent to the first second node 111, that is, the second manager; unlike in FIG. 5, where the first manager was selected. At step 13, in an INVESTIGATION phase, the first node 101 may decide to stop probing, and may then remove the probing intent A from each of the second second node 112 and the first second node 111, at Step 14 and Step 15 respectively. This may trigger an INVESTIGATION phase at each of IM 1 and IM 2 in steps 16 and 17, respectively, about the last report. At step 18, based on the reports received from both intent handlers, the first node 101 may, in an INVESTIGATION phase, define the intent and, in accordance with Action 704, choose the first second node 111 for the intent. Finally, at step 19 the first node 101 may, in accordance with Action 705 and Action 804, set the intent to the first second node 111. The first second node 111 may then, in accordance with Action 805, initiate handling the second intent. Thus, by having the performance metric and contextual information, the decision to select an intent handler changed. This may be understood to offer multiple advantages compared to only having the estimate of the intent such as reducing costs to intent owners, as explained earlier.

As a summarized overview of the foregoing, embodiments herein may be understood to adding a performance metric with contextual information for intent handlers in addition to the current estimates.

Certain embodiments herein may provide one or more of the following technical advantage(s). A first technical advantage may be understood to be that embodiments herein may enable to perform an informed decision-making by an intent owner such as the first node 101 when there may be more than one capable intent handler. This may in turn result in an overall improvement in intent satisfaction since intents may be delegated to more capable intent handlers. Furthermore, the informed decision making that may be enabled by embodiments herein may result in an improved stability of the system since it may minimize the exchange of unmet intent reports through the hierarchy of intent managers.

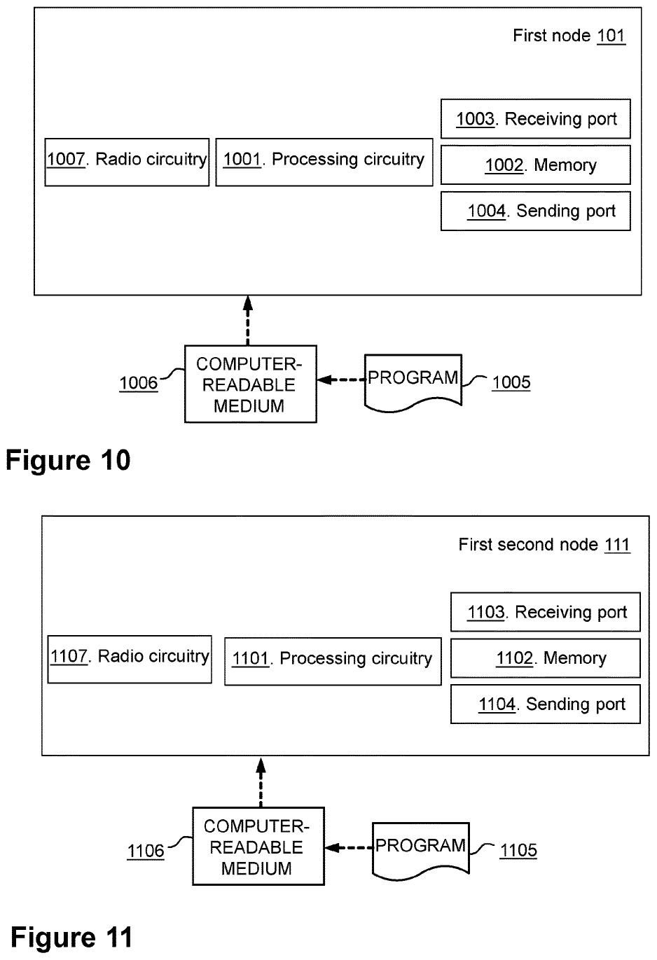

FIG. 10 depicts an example of the arrangement that the first node 101 may comprise to perform the method described in in FIG. 7 and/or FIG. 9. The first node 101 may be understood to be for handling the intent. The first node 101 is configured to operate in the communications network 100.

Several embodiments are comprised herein. It should be noted that the examples herein are not mutually exclusive. One or more embodiments may be combined, where applicable.

All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 101 and will thus not be repeated here. For example, in some embodiments, the first node 101 may be configured to use the PROBE interface.

The first node 101 is configured to obtain the respective first information from the one or more second nodes 110. The one or more second nodes 110 are configured to operate in the communications network 100. The one or more second nodes 110 are configured to be candidates to handle the intent in the communications network 100. The respective first information is configured to indicate: i) the one or more respective first indications of the performance of the respective one or more second nodes 110, ii) the one or more respective second indications of the respective context of the one or more respective first indications, and iii) the one or more respective third indications of the respective estimate of the expected outcome of performing the intent.

The first node 101 is also configured to determine, based on the respective first information configured to be obtained, whether or not one of the one or more second nodes 110, is to handle the intent.

In some embodiments, the first node 101 may be further configured to determine the first second node 111 of the one or more second nodes 110 is to handle the intent, and the first node 101 may be further configured to initiate handling the intent via the first second node 111 configured to be determined.

In some embodiments, the respective first information may be configured to correspond to the first time period, and the obtaining may be configured to be repeated for each of the plurality of second time periods. In some of such embodiments, the determining may be further configured to be based on the respective first information configured to be obtained for the first time period and the plurality of second time periods.

In some embodiments wherein the intent may be configured to be one of the one or more second intents, the first node 101 may be further configured to obtain the first prior indication configured to indicate the first intent to be handled, and the one or more second intents may be configured to be based on the first intent configured to be indicated.

In some of the embodiments wherein the intent may be configured to be one of the one or more second intents, the first node 101 may be further configured to send the second prior indication to the one or more second nodes 110 configured to indicate the respective second intent of the one or more second intents to be handled. In some of such embodiments, the respective first information may be configured to be obtained responsive to the second prior indication configured to be sent.

In some embodiments, at least one of the following may apply: a) the one or more second intents may be configured to be one of: the same, and different from each other, and b) the one or more second intents may be configured to have been split from the first intent.

In some embodiments, at least one of the following options may apply. According to a first option, the one or more second nodes 110 may be configured to be candidates to handle the intent using artificial intelligence methods. According to a second option, the respective estimate of the expected outcome of performing the intent may be configured to be based on using artificial intelligence methods. According to a third option, the first node 101 may be configured to be at least one of an intent owner and an intent handler. According to a fourth option, each of the one or more second nodes 110 may be configured to be an intent handler. According to a fifth option, the intent may be configured to be one intent of the plurality of intents, and the method configured to be performed by the first node 101 may be configured to be repeated for each of the other intents in the plurality of intents.

The embodiments herein in the first node 101 may be implemented through one or more processors, such as a processing circuitry 1001 in the first node 101 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 1002 comprising one or more memory units. The memory 1002 is arranged to be used to store obtained information, store data, configurations, schedulings, and applications etc. to perform the methods herein when being executed in the first node 101.

In some embodiments, the first node 101 may receive information from any of the one or more second nodes 110, e.g., the first second node 111, the second second node 112, the one or more wireless devices 130, and/or another structure in the wireless communications network 100, through a receiving port 1003. In some embodiments, the receiving port 1003 may be, for example, connected to one or more antennas in first node 101. In other embodiments, the first node 101 may receive information from another structure in the wireless communications network 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the first node 101 may be further configured to transmit or send information to e.g., any of the one or more second nodes 110, e.g., the first second node 111, the second second node 112, the one or more wireless devices 130, and/or another structure in the wireless communications network 100, through a sending port 1004, which may be in communication with the processing circuitry 1001, and the memory 1002.

Those skilled in the art will also appreciate that the units comprised within the first node 101 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip.

Also, in some embodiments, the different units comprised within the first node 101 described above as being configured to perform different actions described above may be implemented as one or more applications running on one or more processors such as the processing circuitry 1001.

Thus, the methods according to the embodiments described herein for the first node 101 may be respectively implemented by means of a computer program 1005 product, comprising instructions, i.e., software code portions, which, when executed on at least one processing circuitry 1001, cause the at least one processing circuitry 1001 to carry out the actions described herein, as performed by the first node 101. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the first node 101. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The first node 101 may comprise a communication interface configured to facilitate, or an interface unit to facilitate, communications between the first node 101 and other nodes or devices, e.g., any of the one or more second nodes 110, e.g., the first second node 111, the second second node 112, the one or more wireless devices 130, and/or another structure in the wireless communications network 100. The interface may, for example, include a transceiver configured to transmit and receive radio signals over an air interface in accordance with a suitable standard.

In other embodiments, the first node 101 may comprise a radio circuitry 1007, which may comprise e.g., the receiving port 1003 and the sending port 1004.

The radio circuitry 1007 may be configured to set up and maintain at least a wireless connection with any of the one or more second nodes 110, e.g., the first second node 111, the second second node 112, the one or more wireless devices 130, and/or another structure in the wireless communications network 100. Circuitry may be understood herein as a hardware component.

Hence, embodiments herein also relate to the first node 101 operative to operate in the wireless communications network 100. The first node 101 may comprise the processing circuitry 1001 and the memory 1002, said memory 1002 containing instructions executable by said processing circuitry 1001, whereby the first node 101 is further operative to perform the actions described herein in relation to the first node 101, e.g., in FIG. 7 and/or FIG. 9.

FIG. 11 depicts an example of the arrangement that the first second node 111 may comprise to perform the method described in FIG. 8 and/or FIG. 9. The first second node 111 may be understood to be for handling the intent. The first second node 111 is configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first second node 111 and will thus not be repeated here. For example, in some embodiments, the first second node 111 may be configured to use the PROBE interface.

The first second node 111 is configured to provide the respective first information to the first node 101 configured to operate in the communications network 100. The first second node 111 is configured to be one of the one or more second nodes 110 that are configured to be candidates to handle the intent in the communications network 100. The respective first information is configured to indicate: i) the one or more respective first indications of the performance of the first second node 111, ii) the one or more respective second indications of the respective context of the one or more respective first indications, and iii) the one or more respective third indications of the respective estimate of the expected outcome of performing the intent.

In some embodiments, the first second node 111 may be further configured to receive, based on the respective first information configured to be provided, the fourth indication from the first node 101. The fourth indication may be configured to indicate the request to handle the intent.

In some embodiments, the first second node 111 may be further configured to initiate handling the intent responsive to the fourth indication configured to be received. In some embodiments, the respective first information may be configured to correspond to the first time period, and the providing may be configured to be repeated for each of the plurality of second time periods. In some of such embodiments, the receiving may be configured to be further based on the respective first information configured to be sent for the first time period and the plurality of second time periods.

In some embodiments, the first second node 111 may be further configured to receive the second prior indication from the first node 101 configured to indicate the intent to be handled. In some of such embodiments, the respective first information may be configured to be provided responsive to the second prior indication configured to be received.

In some embodiments, the first second node 111 may be further configured to determine, responsive to the second prior indication configured to be received, the respective estimate of the expected outcome of performing the intent. In such embodiments, the respective first information configured to be provided may comprise the respective estimate, configured to be determined, of the expected outcome of performing the intent.

In some embodiments, at least one of the following options may apply. According to the first option, the one or more second nodes 110 may be configured to be candidates to handle the intent using artificial intelligence methods. According to the second option, the respective estimate of the expected outcome of performing the intent may be configured to be based on the performance using artificial intelligence methods. According to the third option, the first node 101 may be configured to be at least one of an intent owner and an intent handler. According to the fourth option, each of the one or more second nodes 110 may be configured to be an intent handler. According to the fifth option, the intent may be configured to be one intent of the plurality of intents, and the method configured to be performed by the first node 101 may be configured to be repeated for each of the other intents in the plurality of intents.

The embodiments herein in the first second node 111 may be implemented through one or more processors, such as a processing circuitry 1101 in the first second node 111 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first second node 111. One such carrier may be in the form of a CD ROM disc. It is however feasible with other data carriers such as a memory stick. The computer program code may furthermore be provided as pure program code on a server and downloaded to the first second node 111.

The first second node 111 may further comprise a memory 1102 comprising one or more memory units. The memory 1102 is arranged to be used to store obtained information, store data, configurations, schedulings, and applications etc. to perform the methods herein when being executed in the first second node 111.

In some embodiments, the first second node 111 may receive information from, e.g., the first node 101, any of the other one or more second nodes 110, e.g., the second second node 112, the one or more wireless devices 130, and/or another structure in the wireless communications network 100, through a receiving port 1103. In some embodiments, the receiving port 1103 may be, for example, connected to one or more antennas in first second node 111. In other embodiments, the first second node 111 may receive information from another structure in the wireless communications network 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the first second node 111 may be further configured to transmit or send information to e.g., the first node 101, any of the other one or more second nodes 110, e.g., the second second node 112, the one or more wireless devices 130, and/or another structure in the wireless communications network 100, through a sending port 1104, which may be in communication with the processing circuitry 1101, and the memory 1102.

Those skilled in the art will also appreciate that the units comprised within the first second node 111 described above as being configured to perform different actions, may refer to a combination of analog and digital circuits, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip.

Also, in some embodiments, the different units comprised within the first second node 111 described above as being configured to perform different actions described above may be implemented as one or more applications running on one or more processors such as the processing circuitry 1101.

Thus, the methods according to the embodiments described herein for the first second node 111 may be respectively implemented by means of a computer program 1105 product, comprising instructions, i.e., software code portions, which, when executed on at least one processing circuitry 1101, cause the at least one processing circuitry 1101 to carry out the actions described herein, as performed by the first second node 111. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the first second node 111. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The first second node 111 may comprise a communication interface configured to facilitate, or an interface unit to facilitate, communications between the first second node 111 and other nodes or devices, e.g., the first node 101, any of the other one or more second nodes 110, e.g., the second second node 112, the one or more wireless devices 130, and/or another structure in the wireless communications network 100. The interface may, for example, include a transceiver configured to transmit and receive radio signals over an air interface in accordance with a suitable standard.

In other embodiments, the first second node 111 may comprise a radio circuitry 1107, which may comprise e.g., the receiving port 1103 and the sending port 1104.

The radio circuitry 1107 may be configured to set up and maintain at least a wireless connection with the first node 101, any of the other one or more second nodes 110, e.g., the second second node 112, the one or more wireless devices 130, and/or another structure in the wireless communications network 100. Circuitry may be understood herein as a hardware component.

Hence, embodiments herein also relate to the first second node 111 operative to operate in the wireless communications network 100. The first second node 111 may comprise the processing circuitry 1101 and the memory 1102, said memory 1102 containing instructions executable by said processing circuitry 1101, whereby the first second node 111 is further operative to perform the actions described herein in relation to the first second node 111, e.g., in FIG. 8 and/or FIG. 9.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. IG1253 Intent in Autonomous Networks v. 1.3.0.
2. IG1253C Intent Life Cycle Management and Interface v1.1.0
3. Gomes, P. H., Buhrgard, M., Harmatos, J., Mohalik, S. K., Roeland, D., & Niemöller, J. (2021). Intent-driven closed loops for autonomous networks. Journal of ICT Standardization, 257-290.
4. IG1230 Autonomous Networks Technical Architecture v1.1.1
Russell, S. J. (2010). Artificial intelligence a modern approach. Pearson Education, Inc.

1. A computer-implemented method performed by a first node, the method being for handling an intent, wherein first node operates in a communications network, the method comprising:
obtaining respective first information from one or more second nodes, the one or more second nodes operating in the communications network, the one or more second nodes being candidates to handle the intent in the communications network, the respective first information indicating:
one or more respective first indications of a performance of the respective one or more second nodes;
one or more respective second indications of a respective context of the one or more respective first indications; and
one or more respective third indications of a respective estimate of an expected outcome of performing the intent; and
determining, based on the obtained respective first information, whether or not one of the one or more second nodes, is to handle the intent.

2. The method according to claim 1, wherein the first node determines a first second node of the one or more second nodes is to handle the intent, and wherein method further comprises:
initiating handling the intent via the determined first second node.

3. The method according to claim 1, wherein the respective first information corresponds to a first time period, and wherein the obtaining is repeated for each of a plurality of second time periods, and wherein the determining is further based on the obtained respective first information for the first time period and the plurality of second time periods.

4. The method according to claim 1, wherein the intent is one of one or more second intents, and wherein the method further comprises:
obtaining a first prior indication indicating a first intent to be handled, and wherein the one or more second intents are based on the indicated first intent; and
sending a second prior indication to the one or more second nodes indicating a respective second intent of the one or more second intents to be handled, and wherein the respective first information is obtained responsive to the sent second prior indication.

5. The method according to claim 4, wherein at least one of:
the one or more second intents are one of: the same, and different from each other; and
the one or more second intents have been split from the first intent.

6. The method according to claim 1, wherein at least one of:
the one or more second nodes are candidates to handle the intent using artificial intelligence methods;
the respective estimate of the expected outcome of performing the intent is based on using artificial intelligence methods;
the first node is at least one of an intent owner and an intent handler;
each of the one or more second nodes is an intent handler; and
the intent is one intent of a plurality of intents, and wherein the method is repeated for each of the other intents in the plurality of intents.

7. A computer-implemented method performed by a first second node, the method being for handling an intent, first second node operating in a communications network, the method comprising:
providing respective first information to a first node operating in the communications network, wherein the first second node is one of one or more second nodes that are candidates to handle the intent in the communications network, the respective first information indicating:
one or more respective first indications of a performance of the first second node; and
one or more respective second indications of a respective context of the one or more respective first indications; and
one or more respective third indications of a respective estimate of an expected outcome of performing the intent.

8. The method according to claim 7, further comprising:
receiving, based on the provided respective first information, a fourth indication from the first node, the fourth indication indicating a request to handle the intent; and
initiating handling the intent responsive to the received fourth indication.

9. The method according to claim 8, wherein the respective first information corresponds to a first time period, and wherein the providing is repeated for each of a plurality of second time periods, and wherein the receiving is further based on the sent respective first information for the first time period and the plurality of second time periods.

10. The method according to claim 7, further comprising:
receiving a second prior indication from the first node indicating the intent to be handled, and wherein the respective first information is provided responsive to the received second prior indication; and
determining, responsive to the received second prior indication, the respective estimate of the expected outcome of performing the intent, and wherein the provided respective first information comprises the determined respective estimate of the expected outcome of performing the intent.

11. The method according to claim 7, wherein at least one of:
the one or more second nodes are candidates to handle the intent using artificial intelligence methods;
the respective estimate of the expected outcome of performing the intent is based on a performance using artificial intelligence methods;
the first node is at least one of an intent owner and an intent handler,
each of the one or more second nodes is an intent handler; and
the intent is one intent of a plurality of intents, and wherein the method is repeated for each of the other intents in the plurality of intents.

12. A first node, for handling an intent, first node being configured to operate in a communications network, the first node being further configured to:
obtain respective first information from one or more second nodes, the one or more second nodes being configured to operate in the communications network, the one or more second nodes being configured to be candidates to handle the intent in the communications network, the respective first information being configured to indicate:
one or more respective first indications of a performance of the respective one or more second nodes;
one or more respective second indications of a respective context of the one or more respective first indications; and
one or more respective third indications of a respective estimate of an expected outcome of performing the intent; and
determine, based on the respective first information configured to be obtained, whether or not one of the one or more second nodes, is to handle the intent.

13. The first node according to claim 12, wherein the first node is configured to determine a first second node of the one or more second nodes is to handle the intent, and wherein the first node is further configured to:
initiate handling the intent via the first second node configured to be determined.

14. The first node according to claim 12, wherein the respective first information is configured to correspond to a first time period, and wherein the obtaining is configured to be repeated for each of a plurality of second time periods, and wherein the determining is further configured to be based on the respective first information configured to be obtained for the first time period and the plurality of second time periods.

15. The first node according to claim 12, wherein the intent is configured to be one of one or more second intents, and wherein the first node is further configured to:
obtain a first prior indication configured to indicate a first intent to be handled, and wherein the one or more second intents are configured to be based on the first intent configured to be indicated; and
send a second prior indication to the one or more second nodes configured to indicate a respective second intent of the one or more second intents to be handled, and wherein the respective first information is configured to be obtained responsive to the second prior indication configured to be sent.

16. The first node according to claim 15, wherein at least one of:
the one or more second intents are configured to be one of: the same, and different from each other; and
the one or more second intents are configured to have been split from the first intent.

17. The first node according to claim 12, wherein at least one of:
the one or more second nodes are configured to be candidates to handle the intent using artificial intelligence methods;
the respective estimate of the expected outcome of performing the intent is configured to be based on using artificial intelligence methods;
the first node is configured to be at least one of an intent owner and an intent handler;
each of the one or more second nodes is configured to be an intent handler; and
the intent is configured to be one intent of a plurality of intents, and wherein the method configured to be performed by the first node is configured to be repeated for each of the other intents in the plurality of intents.

18. A first second node, for handling an intent, first second node being configured to operate in a communications network, the first second node being configured to:
provide respective first information to a first node configured to operate in the communications network, wherein the first second node is configured to be one of one or more second nodes that are configured to be candidates to handle the intent in the communications network, the respective first information being configured to indicate:
one or more respective first indications of a performance of the first second node;
one or more respective second indications of a respective context of the one or more respective first indications; and
one or more respective third indications of a respective estimate of an expected outcome of performing the intent.

19. The first second node according to claim 18, being further configured to:
receive, based on the respective first information configured to be provided, a fourth indication from the first node, the fourth indication being configured to indicate a request to handle the intent; and
initiate handling the intent responsive to the fourth indication configured to be received.

20. The first second node according to claim 19, wherein the respective first information is configured to correspond to a first time period, and wherein the providing is configured to be repeated for each of a plurality of second time periods, and wherein the receiving is configured to be further based on the respective first information configured to be sent for the first time period and the plurality of second time periods.

21.-26. (canceled)
